(19) United States
(12) Patent Application Publication
(10) Pub. No.: US 2022/0194823 A1
(43) Pub. Date: Jun. 23, 2022

(54) SYSTEMS AND METHODS FOR MEMBRANE-FREE ELECTROLYSIS

(71) Applicant: THE TRUSTEES OF COLUMBIA UNIVERSITY IN THE CITY OF NEW YORK, New York, NY (US)

(72) Inventors: Daniel Esposito, New York, NY (US); Shiho Kawashima, Brooklyn, NY (US); Xueqi Pang, New York, NY (US)

(73) Assignee: THE TRUSTEES OF COLUMBIA UNIVERSITY IN THE CITY OF NEW YORK, New York, NY (US)

(21) Appl. No.: 17/442,245

(22) PCT Filed: Mar. 25, 2020
(86) PCT No.: PCT/US2020/024699

§ 371 Date: Sep. 23, 2021

Related U.S. Application Data
(60) Provisional application No. 62/823,516, filed on Mar. 25, 2019.
(60) Provisional application No. 62/993,888, filed on Mar. 24, 2020.

(51) Int. Cl. C02F 1/461; C25B 9/17; C25B 9/70; C25B 11/02; C25B 15/08; C02F 1/66

(52) U.S. Cl. CPC C02F 1/46109; C25B 9/17; C25B 9/70; C02F 2301/046; C25B 15/08; C02F 1/66; C02F 2001/46161; C25B 11/02

(57) ABSTRACT

A system for treatment of brines includes one or more membrane-less electrolyzers. An influent flow chamber flows an influent stream to a porous anode and cathode. electrochemical reactions at the anode and cathode result in acidic and alkaline effluent streams respectively, including liquid and gaseous streams. The alkaline effluent can be combined with a brine feed stream, resulting in precipitation of alkali earth metals cations by reaction with hydroxyls to form alkali earth metal hydroxides (M(OH)₂, M=Mg²⁺, Ca²⁺). These M(OH)₂ are of interest as a carbon-free feedstock material for cement manufacturing. Additionally, carbon dioxide, such as from flue gas, can be combined with the alkaline effluent to form alkali earth metal carbonates or be concentrated and released upon neutralization of carbon dioxide saturated alkaline effluent with the acidic effluent. Chlorine gas evolved at the anode can also be utilized with hydrogen gas evolved at the cathode as feed streams for a fuel cell for the generation of electricity.

### CROSS REFERENCE TO RELATED APPLICATION(S)

This application is a national stage filing of International Patent Application No. PCT/US2020/024699, filed Mar. 25, 2020, claims the benefit of U.S. Provisional Application Nos. 62/823,516, filed Mar. 25, 2019, and 62/993,888, filed Mar. 24, 2020, which are incorporated by reference as if disclosed herein in their entireties.

### BACKGROUND

Electrolysis is a very important industrial process used to produce a variety of vital chemical building blocks. Processes such as the chlor-alkali process, electro-synthesis of anthraquinone, and electro-fluoridation all play essential roles in the production of chemicals used in our everyday lives. Electrolysis can be an energy efficient process with a significantly lower carbon footprint compared to traditional thermal catalysis processes if the input electricity is derived from a renewable resource such as wind or solar. As of 2006, chemical production by electrochemical processes made up more than 6% of the total electrical generating capacity of the United States, with the most energy intensive process as being performed by the chlor-alkali industry. These processes are used to produce hydrogen gas, caustic soda (sodium hydroxide), and chlorine gas. For the chlor-alkali processes, and most electrolysis processes, the economics are dominated by the cost of electricity, which accounts for a significant fraction of the total manufacturing cost. However, the decreasing costs of electricity from renewable resources and the continued adoption of time-of-use pricing schemes are likely to change the economics of electrochemical processes, shifting importance towards decreasing the capital cost of the electrolyzer system itself.

The process chemistry of the chlor-alkali process is relatively simple but the operational and reactor design issues are vastly complex. The most energy efficient electrolyzer in the chlor-alkali industry is the membrane electrolyzer. The membrane electrolyzer functions by separating anolyte and catholyte streams by means of an ion selective membrane and that only allows cationic species (e.g. Na+, K+, H+) and small amounts of water to pass through it. Diaphragm electrolyzers and mercury electrolytic cells are also used to produce bases, although these technologies are being phased out in favor of membrane reactors. This is due to health and environmental concerns relating to the use of asbestos and mercury, respectively. Key challenges with membrane electrolyzers include the high cost of the ion-selective membranes and their susceptibility to fouling. Further, electrodialysis cells typically rely on multiple membranes and operate at low current densities. Various approaches have been pursued in order to improve the yield, energy efficiency, economics, and environmental impacts of the membrane process.

### SUMMARY

Accordingly, some embodiments of the present disclosure relates to a system for treatment of brines including one or more electrolyzers, each electrolyzer including an influent flow chamber including an influent stream; at least one anode effluent flow chamber including an anode effluent stream; at least one cathode effluent flow chamber including a cathode effluent stream; at least one porous anode positioned at a location within and extending longitudinally along the influent flow chamber, and further positioned to separate the influent flow chamber from the at least one anode effluent flow chamber; and at least one porous cathode positioned at a location within and extending longitudinally along the influent flow chamber, and further positioned to separate the influent flow chamber from the at least one cathode effluent flow chamber, wherein the at least one anode and at least one cathode are positioned obliquely to each other. In some embodiments, the system includes an anode effluent processing unit in fluid communication with the at least one anode effluent flow chamber; a cathode effluent processing unit in fluid communication with the at least one cathode effluent flow chamber; a neutralization unit producing a system effluent stream, the neutralization unit positioned in fluid communication with the anode effluent processing unit, the cathode effluent processing unit, or combination thereof; and a brine inlet stream in fluid communication with the one or more electrolyzers, the anode effluent processing unit, the cathode effluent processing unit, or combinations thereof, and configured to provide a source of brine to the one or more electrolyzers. In some embodiments, the at least one porous anode and the at least one porous cathode include a catalyst layer and a semi-permeable layer disposed on the catalyst layer, the semi-permeable layer being selectively permeable to one or more components of the influent stream.

In some embodiments, the anode effluent stream includes an acid effluent stream and the cathode effluent stream includes a basic effluent stream and a hydrogen gas stream. In some embodiments, the at least one anode effluent flow chamber and at least one cathode effluent flow chamber each include a fluid effluent outlet and a gas effluent outlet.

In some embodiments, the at least one anode includes a plurality of anode fingers and the at least one cathode includes a plurality of cathode fingers, wherein the plurality of anode fingers and the plurality of cathode fingers are interdigitated. In some embodiments, the one or more electrolyzers include a plurality of electrolyzers arranged in series, wherein the influent flow chambers of the plurality of electrolyzers are in fluid communication; the anode effluent flow chambers of the plurality of electrolyzers are in fluid communication; and the cathode effluent flow chambers of the plurality of electrolyzers are in fluid communication.

In some embodiments, one or more recycle flow chambers are configured to recycle at least a portion of the anode effluent stream, the cathode effluent stream, or combinations thereof, to a previous electrolyzer in the plurality of electrolyzers. In some embodiments, the cathode effluent processing unit is in fluid communication with the brine inlet stream, a carbon dioxide inlet stream, or combinations thereof.

In some embodiments, the system includes a separation unit configured to separate the basic effluent stream into an alkaline product stream and an alkaline salt water stream, the separation unit in fluid communication with the cathode effluent processing unit, one or more electrolyzers, and the neutralization unit. In some embodiments, the influent stream includes at least a portion of the alkaline salt water stream. In some embodiments, the alkaline product stream includes alkali earth metal carbonates, alkali earth metal hydroxides, or combinations thereof. In some embodiments, the system effluent stream includes concentrated carbon dioxide, demineralized salt water, sterilized salt water, neutralized salt water, or combinations thereof. In some embodiments, the acid effluent stream includes a chlorine gas stream and the anode effluent processing unit includes a fuel cell, wherein the fuel cell is in fluid communication with the chlorine gas stream and the hydrogen gas stream. In some embodiments, the influent stream includes at least a portion of the system effluent stream. In some embodiments, the influent stream includes neutralized salt water from the neutralization unit.

Some embodiments of the present disclosure relates to a method for treatment of brines including providing one or more electrolyzers, each electrolyzer including an influent flow chamber; at least one anode effluent flow chamber; at least one cathode effluent flow chamber; at least one porous anode positioned at a location within and extending longitudinally along the influent flow chamber, and further positioned to separate the influent flow chamber from the at least one anode effluent flow chamber; and at least one porous cathode positioned at a location within and extending longitudinally along the influent flow chamber, and further positioned to separate the influent flow chamber from the at least one cathode effluent flow chamber, wherein the at least one anode and at least one cathode are positioned obliquely to each other.

In some embodiments, the method includes providing an influent stream to the influent flow chamber, the influent stream including at least one reactant; applying a voltage across the at least one porous anode and the at least one porous cathode; flowing the influent stream through the at least one porous anode and the at least one porous cathode; isolating an anode effluent stream in the at least one anode effluent flow chamber and a cathode effluent stream in the at least one cathode effluent flow chamber, wherein the anode effluent stream includes an acid effluent stream and the cathode effluent stream includes a basic effluent stream and a hydrogen gas stream; providing at least a portion of the anode effluent stream to an anode effluent processing unit; providing at least a portion of the cathode effluent stream to a cathode effluent processing unit; flowing a brine inlet stream, a carbon dioxide inlet stream, or combinations thereof into the cathode effluent processing unit; providing a stream from the anode effluent processing unit and the cathode effluent processing unit to a neutralization unit; and producing a system effluent stream from the neutralization unit. In some embodiments, the method includes separating the cathode effluent stream from the cathode effluent processing unit into an alkaline product stream and an alkaline salt water stream, wherein the alkaline product stream includes alkali earth metal carbonates, alkali earth metal hydroxides, or combinations thereof and recycling at least a portion of the alkaline salt water stream in the influent stream. In some embodiments, the system effluent stream includes concentrated carbon dioxide, demineralized salt water, sterilized salt water, neutralized salt water, or combinations thereof.

Some embodiments of the present disclosure relates to a method for treatment of brines including providing one or more electrolyzers, each electrolyzer including an influent flow chamber; at least one anode effluent flow chamber; at least one cathode effluent flow chamber; at least one porous anode positioned at a location within and extending longitudinally along the influent flow chamber, and further positioned to separate the influent flow chamber from the at least one anode effluent flow chamber; and at least one porous cathode positioned at a location within and extending longitudinally along the influent flow chamber, and further positioned to separate the influent flow chamber from the at least one cathode effluent flow chamber, wherein the at least one anode and at least one cathode are positioned obliquely to each other, and the at least one anode effluent flow chamber and at least one cathode effluent flow chamber each include a fluid effluent outlet and a gas effluent outlet.

In some embodiments, the method includes providing an influent stream to the influent flow chamber, the influent stream including at least one reactant; applying a voltage across the at least one porous anode and the at least one porous cathode; flowing the influent stream through the at least one porous anode and the at least one porous cathode; isolating an anode effluent stream in the at least one anode effluent flow chamber and a cathode effluent stream in the at least one cathode effluent flow chamber, wherein the anode effluent stream includes an acid effluent stream and an oxygen gas stream and the cathode effluent stream includes a basic effluent stream and a hydrogen gas stream; providing one or more recycle flow chambers configured to recycle at least a portion of the anode effluent stream, the cathode effluent stream, or combinations thereof, to the one or more electrolyzers; providing at least a portion of the acid effluent stream to an anode effluent processing unit; providing at least a portion of the basic effluent stream to a cathode effluent processing unit; flowing a brine inlet stream, a carbon dioxide inlet stream, or combinations thereof into the cathode effluent processing unit providing a stream from the anode effluent processing unit to a neutralization unit; separating the cathode effluent stream from the cathode effluent processing unit into an alkaline product stream and an alkaline salt water stream, wherein the alkaline product stream includes alkali earth metal carbonates, alkali earth metal hydroxides, or combinations thereof; recycling a first portion of the alkaline salt water stream in the influent stream; flowing a second portion the alkaline salt water stream to the neutralization unit; and producing a system effluent stream from the neutralization unit. In some embodiments, the system effluent stream includes concentrated carbon dioxide, demineralized salt water, sterilized salt water, neutralized salt water, or combinations thereof.

### BRIEF DESCRIPTION OF THE DRAWINGS

The drawings show embodiments of the disclosed subject matter for the purpose of illustrating the invention. However, it should be understood that the present application is not limited to the precise arrangements and instrumentalities shown in the drawings, wherein:

FIG. 1 is a schematic representation of a system for the treatment of brines according to some embodiments of the present disclosure;

FIG. 2A is a schematic representation of a membrane-less electrolyzer according to some embodiments of the present disclosure;

FIG. 2B is a schematic representation of a membrane-less electrolyzer according to some embodiments of the present disclosure;

FIG. 2C is a schematic representation of a membrane-less electrolyzer according to some embodiments of the present disclosure;

FIG. 2D is a schematic representation of a membrane-less electrolyzer according to some embodiments of the present disclosure;

FIG. 2E is a schematic representation of a membrane-less electrolyzer according to some embodiments of the present disclosure;

FIG. 3 is a schematic representation of an electrode according to some embodiments of the present disclosure;

FIG. 4A is a chart of method for the treatment of brines according to some embodiments of the present disclosure;

FIG. 4B is a chart of method for the treatment of brines according to some embodiments of the present disclosure; and

FIG. 5 is a chart of method for the treatment of brines according to some embodiments of the present disclosure.

### DETAILED DESCRIPTION

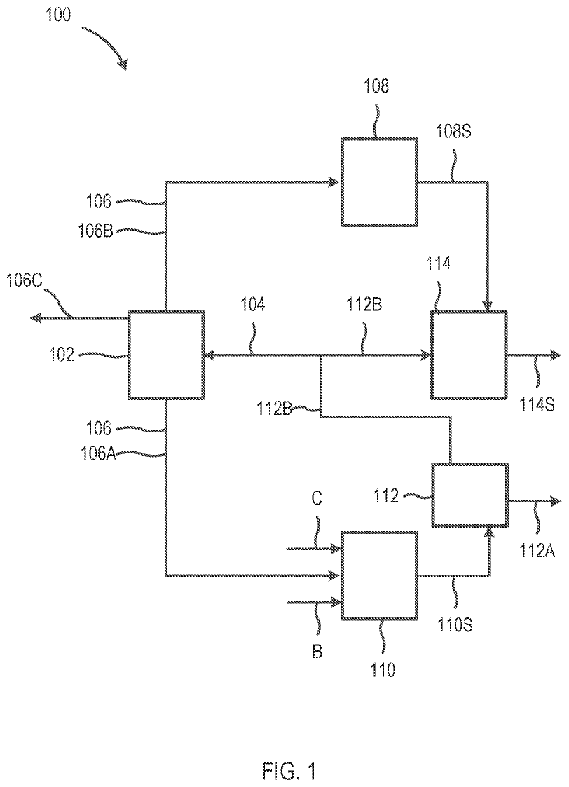

Referring now to FIG. 1, some embodiments of the present disclosure are directed to a system 100 for treatment of brines. As used herein, “brine” refers to aqueous salt solutions including, for example, salt water, waste brine from desalination plant or brine solutions from inland salt water sources, seawater, etc., or combinations thereof. In some embodiments, system 100 includes one or more electrolyzers 102. Electrolyzers 102 are configured to process an influent stream 104 into a plurality of effluent streams 106 via electrolysis. In some embodiments, effluent streams 106 include at least one alkaline effluent stream 106A, at least one acidic stream 106B, at least one gaseous stream 106C, or combinations thereof. In some embodiments, gaseous streams 106C include a hydrogen gas stream, an oxygen gas stream, a chlorine gas stream, or combinations thereof. In some embodiments, influent stream 104 is pretreated before entering electrolyzer 102.

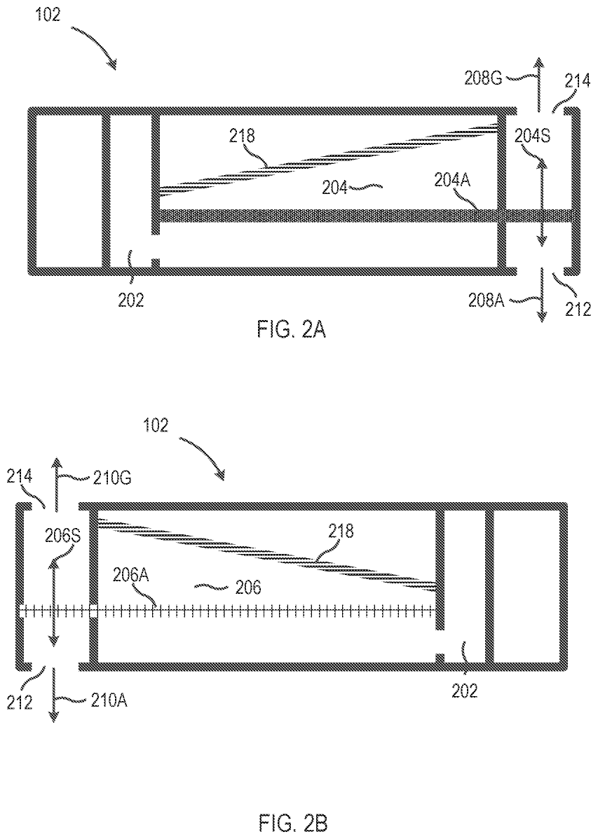

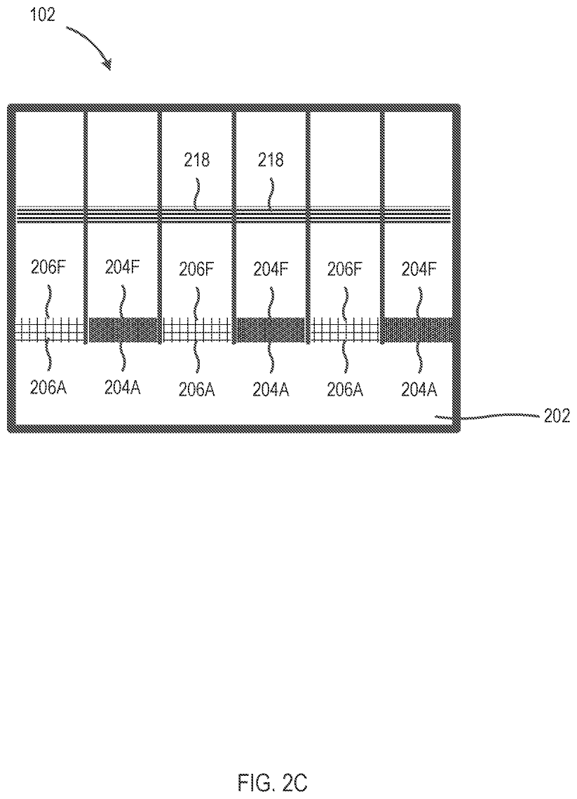

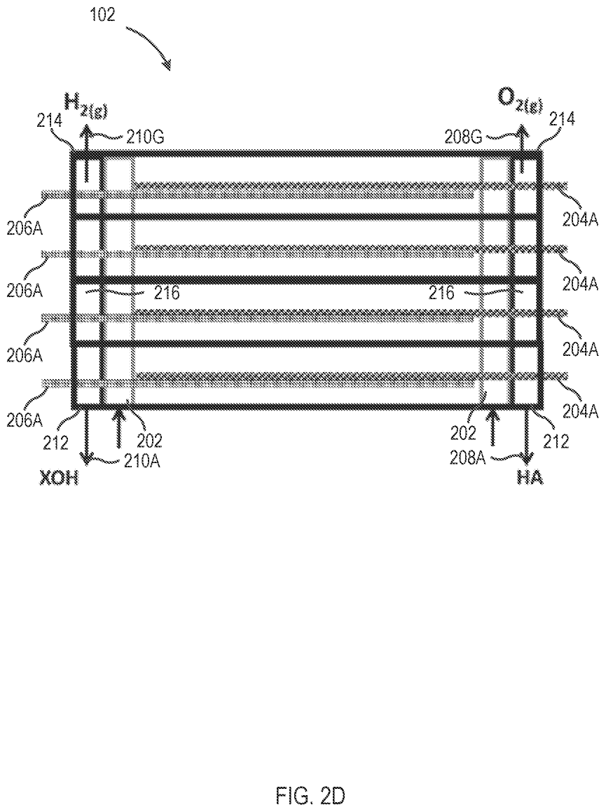

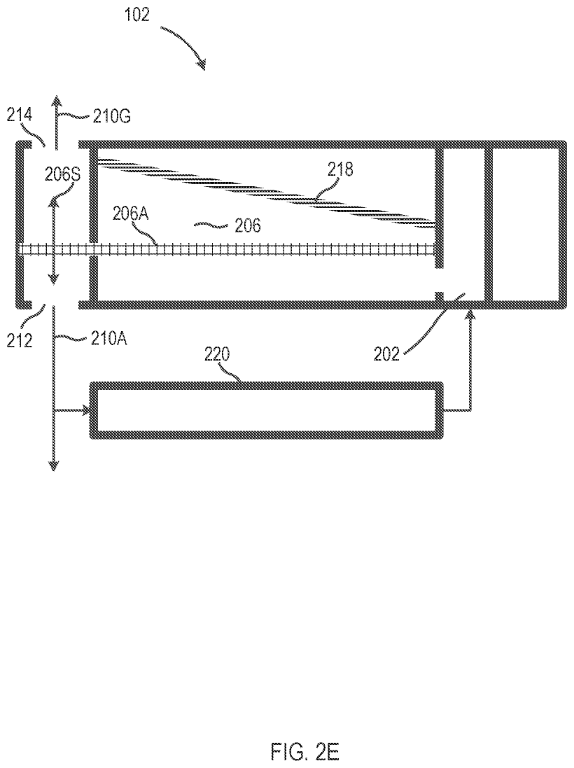

Referring now to FIGS. 2A-2E, electrolyzer 102 includes an influent flow chamber 202 that receives influent stream 104. Influent flow chamber 202 is in fluid communication with at least one anode effluent flow chamber 204 and at least one cathode effluent flow chamber 206. Influent flow chamber 202 is configured to direct influent stream 104 towards anode effluent flow chamber 204 and/or cathode effluent flow chamber 206. In some embodiments, influent flow chamber 202 is configured to receive one or more recycle streams and direct the recycle streams towards anode effluent flow chamber 204 and/or cathode effluent flow chamber 206, as will be discussed in greater detail below.

At least one porous anode 204A is positioned at a location within influent flow chamber 202. In some embodiments, anode 204A extends longitudinally along influent flow chamber 202, e.g., in the direction of flow of influent stream 104. In some embodiments, anode 204A is positioned at an oblique angle to the direction of flow of influent stream 104. In some embodiments, anode 204A is positioned to separate influent flow chamber 202 from anode effluent flow chamber 204. In some embodiments, anode 204A extends across an entire width of anode effluent flow chamber 204. In some embodiments, anode 204A is a wire mesh electrode of any suitable shape.

At least one porous cathode 206A is positioned at a location within influent chamber 202. In some embodiments, cathode 206A extends longitudinally along influent flow chamber 202, e.g., in the direction of flow of influent stream 104. In some embodiments, cathode 206A is positioned at an oblique angle to the direction of flow of influent stream 104. In some embodiments, cathode 206A is positioned to separate influent flow chamber 202 from a cathode effluent flow chamber 206. In some embodiments, cathode 206A extends across an entire width of cathode effluent flow chamber 206. In some embodiments, cathode 206A is a wire mesh electrode of any suitable shape.

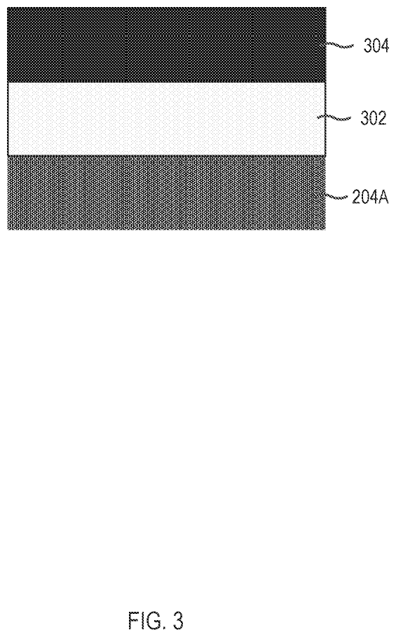

Referring now to FIG. 3, anodes 204A and 206A can be composed of any suitable material which, upon voltage being applied across them in the presence of influent stream 104, cause electrochemical reactions at anode 204A and cathode 206A. In some embodiments, at least one of anode 204A and cathode 206A include a catalyst layer 302 to catalyze the reactions during processing of influent stream 104 by electrolyzer 102, as will be discussed in greater detail below. In some embodiments, at least one of anode 204A and cathode 206A include a semi-permeable layer 304 disposed on catalyst layer 302. In some embodiments, semi-permeable layer 304 is selectively permeable to one or more components of influent stream 104. In some embodiments, semi-permeable layer 304 has membrane functionalities, e.g., being selectively permeable to desired reactant species, e.g., H₂O, while blocking undesirable reactants, e.g., Cl⁻, or impurities that would lead to undesirable products or otherwise degrade the performance of catalyst layer 302.

Referring again to FIGS. 2A-2E, in some embodiments, electrolyzers are membrane-less, e.g., the membrane that separates an anode chamber from a cathode chamber in traditional electrolyzers is absent. In some embodiments, anodes 204A and cathodes 206A are provided in pairs. In some embodiments, the anode/cathode in a pair are positioned adjacent one another. In some embodiments, the anode/cathode in a pair are positioned obliquely to one another. In some embodiments, anode/cathode pairs are positioned at an angle with respect to each other between about 0° and about 180°. In some embodiments, anode/cathode pairs are positioned at an angle with respect to each other above 0°.

As voltage is applied across the anode 204A/cathode 206A pair, ionic current passes between the two porous electrodes by transport of anion (A₋) and cation (X₊) species in influent stream 104, resulting in electrochemical reactions at anode 204A and cathode 206A. These electrochemical reactions result in effluent streams 106 discussed above. In some embodiments, the electrochemical reactions at anode 204A generate an anode effluent stream 204S in anode effluent flow chamber 204. In some embodiments, anode effluent stream 204S includes an acid effluent stream 208A. In some embodiments, acidic stream 106B includes acidic effluent stream 208A, as will be discussed in greater detail below. In some embodiments, anode effluent stream 204S includes a gaseous stream 208G. In some embodiments, acidic stream 106B includes gaseous stream 208G. In some embodiments, gaseous stream 208G includes oxygen gas, chlorine gas, or combinations thereof. In some embodiments, the electrochemical reactions at cathode 206A generate a cathode effluent stream 206S in cathode effluent flow chamber 206. In some embodiments, cathode effluent stream 206S includes a basic effluent stream 210A. In some embodiments, alkaline effluent stream 106A includes basic effluent stream 210A, as will be discussed in greater detail below. In some embodiments, cathode effluent stream 206S includes a gaseous stream 210G. In some embodiments, alkaline effluent stream 106A includes gaseous stream 210G. In some embodiments, gaseous stream 210G includes hydrogen gas.

As discussed above, electrochemical reactions at anode 204A and cathode 206A generate separate effluent streams (204S and 206S, respectively) which continue to flow through electrolyzer 102 in their respective flow channels, while any generated gaseous products (gaseous streams 208G and 210G) are driven upward by their own buoyancy. In some embodiments, the half reaction occurring at cathode 206A is water reduction, producing hydrogen (H₂) as stream 210G and hydroxyls (base, XOH) as 210A. In some embodiments, the half reaction occurring at anode 204A is water oxidation, producing oxygen gas (O₂) as 208G and protons (acid, HA) as 208A. In some embodiments, the oxidation half reaction includes a chlorine evolution reaction, resulting in the production of chlorine gas (Cl₂) in 208G. In some embodiments, anode effluent flow chamber 204 and cathode effluent flow chamber 206 each include at least one fluid effluent outlet 212 and at least one gas effluent outlet 214 to remove reaction products, e.g., 204S and 206S, from electrolyzer 102. Referring specifically to FIG. 2D, in some embodiments, electrolyzer 102 includes one or more product collection manifolds 216 in fluid communication with anode effluent flow chamber 204 and cathode effluent flow chamber 206 and at least one fluid effluent outlet 212 and at least one gas effluent outlet 214. In some embodiments, collection manifolds 216 are configured to collect reaction products, e.g., 204S and 206S, from a plurality of flow chambers 204 and 206, before removing those products from electrolyzer 102 via outlets 212 and 214, respectively.

In some embodiments, system 100 includes a plurality of electolyzers 102. In some embodiments, electrolyzer 102 includes a plurality of anodes 204A and cathodes 206A. Referring specifically to FIG. 2C, in some embodiments, anode 204A includes a plurality of anode fingers 204F and cathode 206A includes a plurality of cathode fingers 206F. In some embodiments, anode fingers 204F and cathode fingers 206F are interdigitated. In some embodiments, flow paths of anode effluent stream 204S and cathode effluent stream 206S are counter each other. In some embodiments, the plurality of electrolyzers 102 share a common influent flow chamber 202, product collection manifolds 216, etc. In some embodiments, influent flow chambers 202 of the plurality of electrolyzers 102 are in fluid communication. In some embodiments, anode effluent flow chambers 204 of the plurality of electrolyzers 102 are in fluid communication. In some embodiments, cathode effluent flow chambers 206 of the plurality of electrolyzers 102 are in fluid communication. In the exemplary embodiment of FIG. 2D, once gaseous and liquid products reach the vertical product collection manifolds 216, they may merge with products from other cells, with gaseous products floating upwards and liquid products being drawn downward where they are eventually removed.

In some embodiments, liquid and gaseous product species produced in given effluent chamber may be separated within or outside of electrolyzer 102. Referring now to FIGS. 2A and 2B, in some embodiments, electrolyzer 102 is configured to collect gaseous streams as they are driven upwards. In some embodiments, flow chambers 204 and 206 include collection baffles 218 to help direct gaseous product streams, e.g., 208G and 210G, towards gas effluent outlets 214. In some embodiments, collection baffles 218 in anode effluent flow chamber 204 are tilted in opposite directions to that in cathode effluent flow chamber 206, such that the gaseous anode products 208G and gaseous cathode products 210G flow to separate gaseous product collection manifolds 216, e.g., located at opposite ends of electrolyzer 102.

Referring now to FIG. 2E, in some embodiments, electrolyzer 102 includes one or more recycle flow chambers 220. In some embodiments, recycle flow chambers 220 are configured to recycle at least a portion of anode effluent stream 204S, cathode effluent stream 206S, or combinations thereof. In some embodiments, recycle flow chambers 220 recycle streams to a previous electrolyzer 102 in a system embodiment with a plurality of electrolyzers. The streams are recycled in a manner that increases the average residence time of liquid passing through the device, allowing for enhanced acidification or basification of the streams. By way of example, during operation, fresh brine that is fed into the cell is directed towards the divider separating the porous anode and porous cathode. In an exemplary embodiment, two trains of electrolyzers are connected in series. In at least one train, the most acidic effluent stream is directly fed into the next (downstream) electrolyzer, while the other (higher pH) effluent stream is recycled to the feed stream of the previous (upstream) electrolyzer that should have the same or similar pH. Effluent streams with increasing levels of acidity are produced moving further along the electrolyzer train. In at least one other electrolyzer train, the most basic effluent stream is directly fed into the next (downstream) electrolyzer, while the other (lower pH) effluent stream is recycled to the feed stream of the previous (upstream) electrolyzer that should have the same or similar pH. Effluent streams with increasing levels of basicity are produced moving further along the electrolyzer train. In some embodiments, additional brine may be injected into the electrolyzer train(s) at any suitable point.

Referring again to FIG. 1, system 100 includes an anode effluent processing unit 108 in fluid communication with electrolyzer 102. In some embodiments, anode effluent processing unit 108 is in fluid communication anode effluent flow chamber 204. In some embodiments, anode effluent processing unit 108 is in fluid contact with at least a portion of cathode effluent stream 206S, e.g., gaseous stream 210G. In some embodiments, anode effluent processing unit 108 produces one or more unit outlet streams 108S. In some embodiments, one unit outlet stream 108S includes a brine stream that is recycled back to electrolyzer 102 in influent stream 104.

In some embodiments, anode effluent processing unit 108 is a holding container for at least a portion of anode effluent stream 204S. In some embodiments, anode effluent processing unit 108 is configured to process at least a portion of anode effluent stream 204S, e.g., into unit outlet stream 108S. In some embodiments, anode effluent processing unit 108 is in fluid communication with acid effluent stream 208A. In some embodiments, anode effluent processing unit 108 is in fluid communication with gaseous effluent stream 208G. In some embodiments, anode effluent processing unit 108 includes a fuel cell, release unit, sterilization unit, or combinations thereof.

In embodiments where anode effluent processing unit 108 is a fuel cell, an oxidation reaction in electrolyzer 102 produces chlorine gas as a part of anode effluent stream 204S, e.g., gaseous stream 208G. In these embodiments, gaseous stream 210G from cathode effluent stream 206S includes hydrogen gas. Gaseous streams 208G and 210G are each fed to the fuel cell, which produces electricity and hydrochloric acid (HCl) as unit outlet stream 108S. In some embodiments, a portion of the HCl is used to neutralize basic streams evolved elsewhere in system 100, as will be discussed in greater detail below.

Still referring to FIG. 1, in some embodiments, system 100 includes a cathode effluent processing unit 110 in fluid communication with electrolyzer 102. In some embodiments, cathode effluent processing unit 110 is in fluid communication with cathode effluent flow chamber 206. In some embodiments, cathode effluent processing unit 110 produces one or more unit outlet streams 110S.

In some embodiments, cathode effluent processing unit 110 is configured to process at least a portion of cathode effluent stream 206S, e.g., into unit outlet stream 110S. In some embodiments, cathode effluent processing unit 110 is in fluid communication with basic effluent stream 210A. In some embodiments, cathode effluent processing unit 110 is in fluid communication with gaseous stream 210G. In some embodiments, cathode effluent processing unit 110 includes a holding tank, capture tank, mixing tank, sterilization unit, or combinations thereof. In some embodiments, cathode effluent processing unit 110 is in fluid communication with a brine inlet stream B, a carbon dioxide inlet stream C, or combinations thereof. In some embodiments, the source of carbon dioxide in the carbon dioxide inlet stream is a flue gas. In some embodiments, cathode effluent processing unit 110 contacts basic effluent stream 210A, e.g., alkaline salt water, with the brine, carbon dioxide, or combinations thereof. Without wishing to be bound by theory, in some embodiments, basic effluent stream 210A causes precipitation of alkali earth metals cations by reaction with hydroxyls to form alkali earth metal hydroxides (M(OH)₂, M=Mg²⁺, Ca²⁺). These M(OH)₂ are of interest as a carbon-free feedstock material for cement manufacturing. In some embodiments, reaction with carbon dioxide from the carbon dioxide stream forms alkali earth metal carbonates M(CO₃) instead of M(OH)₂.

In some embodiments, system 100 includes a separation unit 112. In some embodiments, separation unit 112 is in fluid communication with cathode effluent processing unit 110 and configured to receive unit outlet stream 110S. In some embodiments, unit outlet stream 110S includes basic effluent stream 210A processed by cathode effluent processing unit 110. In some embodiments, separation unit 112 separates basic effluent stream 210A into at least an alkaline product stream 112A and an alkaline salt water stream 112B. Separation unit 112 can be any suitable separator or series of separators for performing liquid/solid separation techniques, including but not limited to, filtration, hydrocyclone separators, or combinations thereof. In some embodiments, alkaline product stream 112A includes alkali earth metal carbonates, alkali earth metal hydroxides, or combinations thereof. In some embodiments, alkaline product stream 112A is removed from system 100 as a desired product, e.g., for cement manufacturing. In some embodiments, separation unit 112 is in fluid communication with electrolyzer 102. In some embodiments, at least a portion of alkaline salt water stream 112B is recycled in influent stream 104.

In some embodiments, system 100 includes a neutralization unit 114. In some embodiments, neutralization unit 114 is in fluid communication with electrolyzer 102, anode effluent processing unit 108, cathode effluent processing unit 110, separator 112, or combinations thereof. In some embodiments, neutralization unit 114 produces a system effluent stream 114S. In some embodiments, system effluent stream 114S includes concentrated carbon dioxide, demineralized salt water, sterilized salt water, neutralized salt water, or combinations thereof. In some embodiments, at least a portion of system effluent stream 114S, e.g., neutralized salt water, is recycled in influent stream 104.

In some embodiments, neutralization unit 114 combines outlet streams 108S, typically basic, and 110S, typically acidic, to neutralize the two streams. In some embodiments, neutralization unit 114 is fed at least a portion of alkaline salt water stream 112B from separation unit 112. Upon combination in neutralization unit 114 with outlet stream 108S, alkaline salt water stream 112B is neutralized and can be removed from system 100 as demineralized salt water. In some embodiments, neutralization unit 114 is fed basic effluent stream 210A saturated with carbon dioxide by cathode effluent processing unit 110. Upon combination in neutralization unit 114 with outlet stream 108S, saturated basic effluent stream 210A releases concentrated carbon dioxide that can be removed from system 100. The remaining neutralized salt water can then also be removed as a product, or recycled back to electrolyzer 102 in influent stream 104.

As discussed above, in some embodiments, system 100 includes brine inlet stream B. In some embodiments, brine inlet stream B is in fluid communication with electrolyzers 102, anode effluent processing unit 108, cathode effluent processing unit 110, or combinations thereof. Brine inlet stream B is configured to provide brine to system 100 for treatment, e.g., by electrolyzers 102. In some embodiments, brine inlet stream B is pretreated before entering system 100. In some embodiments, brine inlet stream B is pretreated before entering electrolyzers 102, anode effluent processing unit 108, cathode effluent processing unit 110, or combinations thereof.

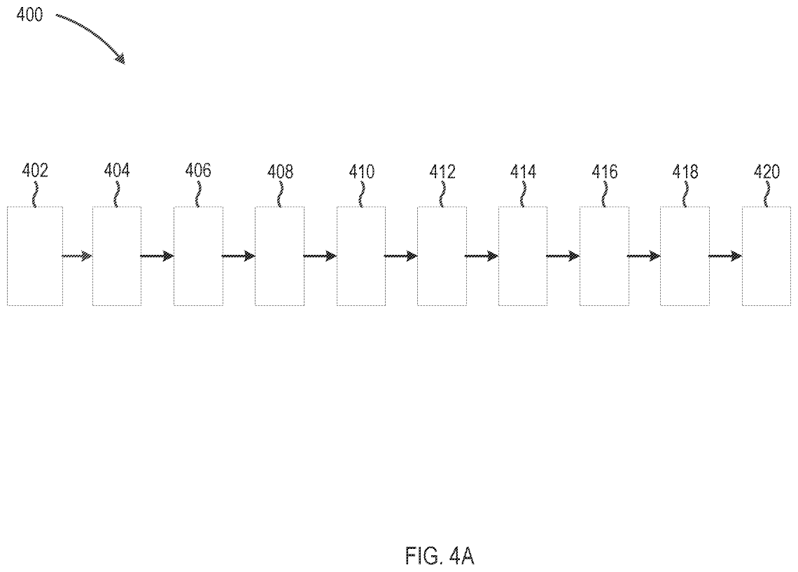

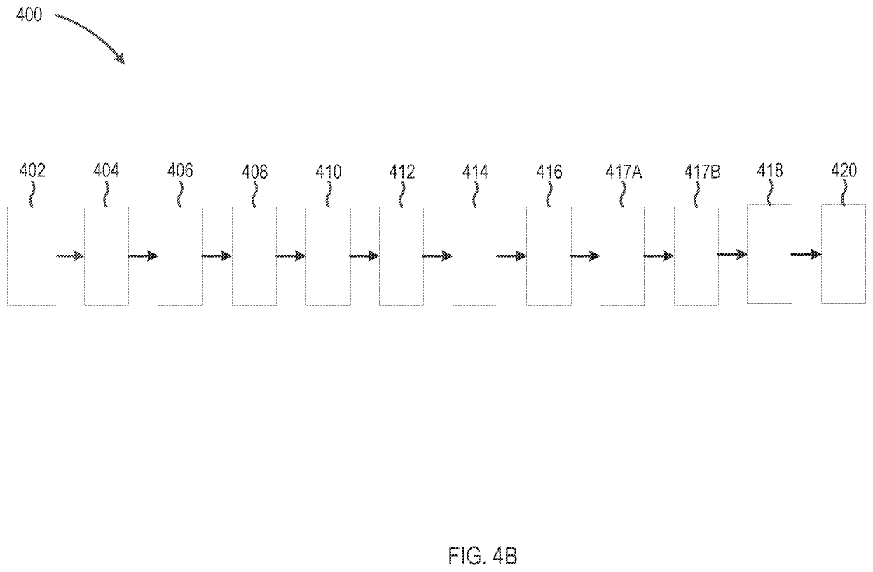

Referring now to FIG. 4A, some embodiments of the present disclosure are directed to a method 400 for treatment of brines. In some embodiments, method 400 utilizes a system consistent with the embodiments of system 100 described above. In some embodiments, at 402, one or more electrolyzers are provided. As discussed above, in some embodiments, the one or more electrolyzers include an influent flow chamber, at least one anode effluent flow chamber, at least one cathode effluent flow chamber, at least one porous anode positioned at a location within and extending longitudinally along the influent flow chamber, and further positioned to separate the influent flow chamber from the at least one anode effluent flow chamber, and at least one porous cathode positioned at a location within and extending longitudinally along the influent flow chamber, and further positioned to separate the influent flow chamber from the at least one cathode effluent flow chamber, wherein the at least one anode and at least one cathode are positioned obliquely to each other. As also discussed above, in some embodiments, the electrolyzers are membrane-less. At 404, an influent stream is provided to the influent flow chamber, the influent stream including at least one reactant. At 406, a voltage is applied across the at least one porous anode and the at least one porous cathode. At 408, the influent stream flows through the at least one porous anode and the at least one porous cathode. At 410, an anode effluent stream is isolated in the at least one anode effluent flow chamber and a cathode effluent stream in the at least one cathode effluent flow chamber, wherein the anode effluent stream includes an acid effluent stream and the cathode effluent stream includes a basic effluent stream and a hydrogen gas stream. At 412, at least a portion of the anode effluent stream is provided to an anode effluent processing unit. At 414, at least a portion of the cathode effluent stream is provided to a cathode effluent processing unit. At 416, a brine inlet stream, a carbon dioxide inlet stream, or combinations thereof flows into the cathode effluent processing unit. At 418, a stream is provided to a neutralization unit from the anode effluent processing unit and the cathode effluent processing unit. At 420, a system effluent stream is produced from the neutralization unit.

Referring now to FIG. 4B, in some embodiments, method 400 includes, at 417A, separating the cathode effluent stream from the cathode effluent processing unit into an alkaline product stream and an alkaline salt water stream, wherein the alkaline product stream includes alkali earth metal carbonates, alkali earth metal hydroxides, or combinations thereof. At 417B, at least a portion of the alkaline salt water stream is recycled in the influent stream.

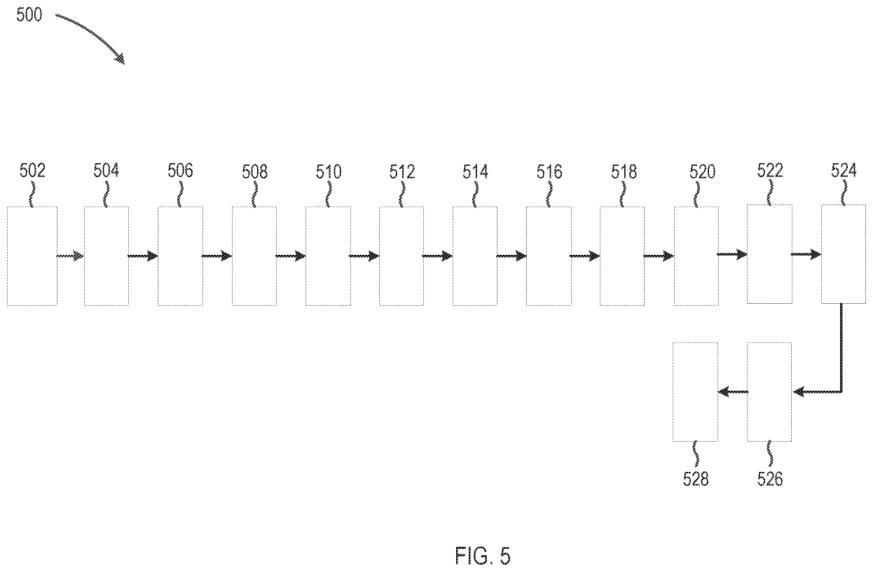

Referring now to FIG. 5, some embodiments of the present disclosure are directed to a method 500 for treatment of brines. In some embodiments, method 500 utilizes a system consistent with the embodiments of system 100 described above. In some embodiments, at 502 or more electrolyzers are provided. As discussed above in some embodiments, the one or more electrolyzers include an influent flow chamber, at least one anode effluent flow chamber, at least one cathode effluent flow chamber, at least one porous anode positioned at a location within and extending longitudinally along the influent flow chamber, and further positioned to separate the influent flow chamber from the at least one anode effluent flow chamber, and at least one porous cathode positioned at a location within and extending longitudinally along the influent flow chamber, and further positioned to separate the influent flow chamber from the at least one cathode effluent flow chamber, wherein the at least one anode and at least one cathode are positioned obliquely to each other, and the at least one anode effluent flow chamber and at least one cathode effluent flow chamber each include a fluid effluent outlet and a gas effluent outlet. As also discussed above, in some embodiments, the electrolyzers are membrane-less. At 504, an influent stream is provided to the influent flow chamber, the influent stream including at least one reactant. At 506, a voltage is provided across the at least one porous anode and the at least one porous cathode. At 508, the influent stream flows through the at least one porous anode and the at least one porous cathode. At 510 an anode effluent stream is isolated in the at least one anode effluent flow chamber and a cathode effluent stream in the at least one cathode effluent flow chamber, wherein the anode effluent stream includes an acid effluent stream and an oxygen gas stream and the cathode effluent stream includes a basic effluent stream and a hydrogen gas stream. At 512, one or more recycle flow chambers are provided, which are configured to recycle at least a portion of the anode effluent stream, the cathode effluent stream, or combinations thereof, to the one or more electrolyzers. At 514, at least a portion of the acid effluent stream is provided to an anode effluent processing unit. At 516, at least a portion of the basic effluent stream is provided to a cathode effluent processing unit. At 518, a brine inlet stream, a carbon dioxide inlet stream, or combinations thereof flows into the cathode effluent processing unit. At 520, a stream from the anode effluent processing unit is provided to a neutralization unit. At 522, the cathode effluent stream is separated from the cathode effluent processing unit into an alkaline product stream and an alkaline salt water stream, wherein the alkaline product stream includes alkali earth metal carbonates, alkali earth metal hydroxides, or combinations thereof. At 524, a first portion of the alkaline salt water stream is recycled in the influent stream. At 526, a second portion the alkaline salt water stream flows to the neutralization unit. At 528, a system effluent stream is produced from the neutralization unit.

By way of example, membrane-less electrolyzers powered by electricity are used to split salt water into acidic and alkaline effluent streams (along with H₂/O₂ co-products), where the alkaline cathode effluent is used to cause precipitation of alkali earth metals cations by reaction with hydroxyls to form alkali earth metal hydroxides (M(OH)₂, M=Mg²⁺, Ca²⁺) as the desired product. These M(OH)₂ are of interest as a carbon-free feedstock material for cement manufacturing. In some embodiments, a fraction of the alkaline effluent leaving the separation stage is recycled to the electrolyzer, while the rest is sent to a mixing or neutralization vessel where it is mixed with acidic effluent from the electrolyzer to return the water stream to a desired discharge pH. In one embodiment, CO₂ is injected into the mixing tank or separation unit(s) to produce alkali earth metal carbonates, e.g., M(CO₃) instead of M(OH)₂.

Methods and system of the present disclosure are advantageous to provide acid, base, hydrogen gas, and oxygen gas products from salt water (brine) in a durable and cost-effective manner. The system includes an electrolyzer employing porous electrodes to convert aqueous salt solutions (brine) into these valuable products. The systems of the present disclosure are scalable and allow higher concentrations of acid and base products to be produced with built-in structures for separating and collecting gaseous products from the liquid products. Finally, as discussed above, the systems of the present disclosure are advantageous for use in a broad range of applications, including capturing alkali earth metal hydroxides and/or carbonates from seawater, capturing and concentrating carbon dioxide, sterilizing salt water, and simultaneously treating salt water and capturing/concentrating CO₂.

Disclosure relevant to the instant application can also be found in the co-owned U.S. patent application Ser. No. 15/269,804, filed Sep. 19, 2016, the content of which is incorporated herein by reference in its entirety.

Although the invention has been described and illustrated with respect to exemplary embodiments thereof, it should be understood by those skilled in the art that the foregoing and various other changes, omissions and additions may be made therein and thereto, without parting from the spirit and scope of the present invention.

What is claimed is:

1. A system for treatment of brines, comprising:
one or more electrolyzers, each electrolyzer including:
an influent flow chamber including an influent stream;
at least one anode effluent flow chamber including an anode effluent stream;
at least one cathode effluent flow chamber including a cathode effluent stream;
at least one porous anode positioned at a location within and extending longitudinally along the influent flow chamber, and further positioned to separate the influent flow chamber from the at least one anode effluent flow chamber; and
at least one porous cathode positioned at a location within and extending longitudinally along the influent flow chamber, and further positioned to separate the influent flow chamber from the at least one cathode effluent flow chamber,
wherein the at least one anode and at least one cathode are positioned obliquely to each other;
an anode effluent processing unit in fluid communication with the at least one anode effluent flow chamber;
a cathode effluent processing unit in fluid communication with the at least one cathode effluent flow chamber;
a neutralization unit producing a system effluent stream, the neutralization unit positioned in fluid communication with the anode effluent processing unit, the cathode effluent processing unit, or combination thereof; and
a brine inlet stream in fluid communication with the one or more electrolyzers, the anode effluent processing unit, the cathode effluent processing unit, or combinations thereof, and configured to provide a source of brine to the one or more electrolyzers.

2. The system according to claim 1, wherein the anode effluent stream includes an acid effluent stream and the cathode effluent stream includes a basic effluent stream and a hydrogen gas stream.

3. The system according to claim 2, wherein the at least one anode effluent flow chamber and at least one cathode effluent flow chamber each include a fluid effluent outlet and a gas effluent outlet.

4. The system according to claim 1, wherein the at least one anode includes a plurality of anode fingers and the at least one cathode includes a plurality of cathode fingers, wherein the plurality of anode fingers and the plurality of cathode fingers are interdigitated.

5. The system according to claim 1, wherein the one or more electrolyzers include a plurality of electrolyzers arranged in series, wherein:
the influent flow chambers of the plurality of electrolyzers are in fluid communication;
the anode effluent flow chambers of the plurality of electrolyzers are in fluid communication; and
the cathode effluent flow chambers of the plurality of electrolyzers are in fluid communication.

6. The system according to claim 5, further comprising one or more recycle flow chambers configured to recycle at least a portion of the anode effluent stream, the cathode effluent stream, or combinations thereof, to a previous electrolyzer in the plurality of electrolyzers.

7. The system according to claim 2, wherein the cathode effluent processing unit is in fluid communication with the brine inlet stream, a carbon dioxide inlet stream, or combinations thereof.

8. The system according to claim 7, further comprising:
a separation unit configured to separate the basic effluent stream into an alkaline product stream and an alkaline salt water stream, the separation unit in fluid communication with the cathode effluent processing unit, one or more electrolyzers, and the neutralization unit.

9. The system according to claim 8, wherein the influent stream includes at least a portion of the alkaline salt water stream.

10. The system according to claim 8, wherein the alkaline product stream includes alkali earth metal carbonates, alkali earth metal hydroxides, or combinations thereof.

11. The system according to claim 7, wherein the system effluent stream includes concentrated carbon dioxide, demineralized salt water, sterilized salt water, neutralized salt water, or combinations thereof.

12. The system according to claim 2, wherein the acid effluent stream includes a chlorine gas stream and the anode effluent processing unit includes a fuel cell, wherein the fuel cell is in fluid communication with the chlorine gas stream and the hydrogen gas stream.

13. The system according to claim 1, wherein the influent stream includes at least a portion of the system effluent stream.

14. The system according to claim 13, wherein the influent stream includes neutralized salt water from the neutralization unit.

15. The system according to claim 1, wherein the at least one porous anode and the at least one porous cathode include:
a catalyst layer; and
a semi-permeable layer disposed on the catalyst layer, the semi-permeable layer being selectively permeable to one or more components of the influent stream.

16. A method for treatment of brines, comprising:
providing one or more electrolyzers, each electrolyzer including:
an influent flow chamber;
at least one anode effluent flow chamber;
at least one cathode effluent flow chamber;
at least one porous anode positioned at a location within and extending longitudinally along the influent flow chamber, and further positioned to separate the influent flow chamber from the at least one anode effluent flow chamber; and
at least one porous cathode positioned at a location within and extending longitudinally along the influent flow chamber, and further positioned to separate the influent flow chamber from the at least one cathode effluent flow chamber,
wherein the at least one anode and at least one cathode are positioned obliquely to each other;
providing an influent stream to the influent flow chamber, the influent stream including at least one reactant;
applying a voltage across the at least one porous anode and the at least one porous cathode;
flowing the influent stream through the at least one porous anode and the at least one porous cathode;
isolating an anode effluent stream in the at least one anode effluent flow chamber and a cathode effluent stream in the at least one cathode effluent flow chamber, wherein the anode effluent stream includes an acid effluent stream and the cathode effluent stream includes a basic effluent stream and a hydrogen gas stream;
providing at least a portion of the anode effluent stream to an anode effluent processing unit;
providing at least a portion of the cathode effluent stream to a cathode effluent processing unit;
flowing a brine inlet stream, a carbon dioxide inlet stream, or combinations thereof into the cathode effluent processing unit;
providing a stream from the anode effluent processing unit and the cathode effluent processing unit to a neutralization unit; and
producing a system effluent stream from the neutralization unit.

17. The method according to claim 16, wherein the system effluent stream includes concentrated carbon dioxide, demineralized salt water, sterilized salt water, neutralized salt water, or combinations thereof.

18. The method according to claim 16, further comprising:
separating the cathode effluent stream from the cathode effluent processing unit into an alkaline product stream and an alkaline salt water stream, wherein the alkaline product stream includes alkali earth metal carbonates, alkali earth metal hydroxides, or combinations thereof; and
recycling at least a portion of the alkaline salt water stream in the influent stream.

19. A method for treatment of brines, comprising:
providing one or more electrolyzers, each electrolyzer including:
an influent flow chamber;
at least one anode effluent flow chamber;
at least one cathode effluent flow chamber;
at least one porous anode positioned at a location within and extending longitudinally along the influent flow chamber, and further positioned to separate the influent flow chamber from the at least one anode effluent flow chamber; and
at least one porous cathode positioned at a location within and extending longitudinally along the influent flow chamber, and further positioned to separate the influent flow chamber from the at least one cathode effluent flow chamber,
wherein the at least one anode and at least one cathode are positioned obliquely to each other, and the at least one anode effluent flow chamber and at least one cathode effluent flow chamber each include a fluid effluent outlet and a gas effluent outlet;
providing an influent stream to the influent flow chamber, the influent stream including at least one reactant;
applying a voltage across the at least one porous anode and the at least one porous cathode;
flowing the influent stream through the at least one porous anode and the at least one porous cathode;
isolating an anode effluent stream in the at least one anode effluent flow chamber and a cathode effluent stream in the at least one cathode effluent flow chamber, wherein the anode effluent stream includes an acid effluent stream and an oxygen gas stream and the cathode effluent stream includes a basic effluent stream and a hydrogen gas stream;
providing one or more recycle flow chambers configured to recycle at least a portion of the anode effluent stream, the cathode effluent stream, or combinations thereof, to the one or more electrolyzers;
providing at least a portion of the acid effluent stream to an anode effluent processing unit;
providing at least a portion of the basic effluent stream to a cathode effluent processing unit;
flowing a brine inlet stream, a carbon dioxide inlet stream, or combinations thereof into the cathode effluent processing unit
providing a stream from the anode effluent processing unit to a neutralization unit;
separating the cathode effluent stream from the cathode effluent processing unit into an alkaline product stream and an alkaline salt water stream, wherein the alkaline product stream includes alkali earth metal carbonates, alkali earth metal hydroxides, or combinations thereof;
recycling a first portion of the alkaline salt water stream in the influent stream;
flowing a second portion the alkaline salt water stream to the neutralization unit; and
producing a system effluent stream from the neutralization unit.

20. The method according to claim 19, wherein the system effluent stream includes concentrated carbon dioxide, demineralized salt water, sterilized salt water, neutralized salt water, or combinations thereof.
